(19) United States
(12) Patent Application Publication
(10) Pub. No.: US 2012/0232990 A1
(43) Pub. Date: Sep. 13, 2012

(54) APPARATUS FOR PROVIDING PERSONALIZED RELATED ADVERTISEMENT, MOBILE TERMINAL FOR PLAYING RELATED ADVERTISEMENT, AND METHOD FOR PROVIDING PERSONALIZED RELATED ADVERTISEMENT

(75) Inventors: Min Sik PARK, Daejeon (KR); Jin Woo HONG, Daejeon (KR); Chung Hyun AHN, Daejeon (KR)

(73) Assignee: Electronics and Telecommunications Research Institute, Daejeon (KR)

(21) Appl. No.: 13/360,047

(22) Filed: Jan. 27, 2012

(30) Foreign Application Priority Data
Mar. 11, 2011 (KR) 10-2011-0021966

(51) Int. Cl. G06Q 30/02

(52) U.S. Cl. 705/14.55; 705/14.64

(57) ABSTRACT

Disclosed is an apparatus for providing personalized related advertisements including: a communication unit for receiving ID information required for searching for advertisements related to a broadcast advertisement and for transmitting converted related advertisements to a mobile terminal; a search unit for searching for the related advertisements by means of the ID information; and a conversion unit for converting the searched related advertisements to a format to be played in the mobile terminal.

### CROSS-REFERENCE TO RELATED APPLICATIONS

This application claims priority to and the benefit of Korean Patent Application No. 10-2011-0021966 filed in the Korean Intellectual Property Office on MARCH 11, 2011, the entire contents of which are incorporated herein by reference.

### TECHNICAL FIELD

The present invention relates to an apparatus for providing personalized related advertisements, a mobile terminal for playing related advertisements and a method for providing personalized related advertisements in order to provide advertisements related to a broadcast advertisement.

### BACKGROUND ART

Today, with the trend of personalized, intelligent and multifunction networks, computers, communication and home appliances, the number of services for IT devices is gradually increasing.

Among them, lately, many advertisement services have been actively provided for communication users. An important issue for the services is to efficiently deliver the advertisement services. Another important issue for improving advertisement efficiency is to select targets appropriate for delivering and then exposing advertisements.

Since TV stations currently provide only one type of advertisements and cannot provide advertisements appropriate for users who are in a variety of situations and of various tastes, the advertisements are not highly cost-effective as compared to advertisements on the Internet in which a main advertisement and various purchase information related thereto is provided.

Further, since current broadcast advertisements aim only at providing information for specific goods due to the feature of broadcasting as a medium, users who are not interested in the relevant goods or have already purchased the goods are likely to be uninterested in the advertisements in most cases.

To address such a problem, attempts have been made to provide users with appropriate broadcast advertisements and various pieces of additional purchase information related thereto. A known method is that advertisers produce additional purchase information related to broadcast advertisements as supplementary data to data broadcasting to automatically display the supplementary data on the screen of a broadcasting terminal while a relevant broadcast advertisement is on the air.

### SUMMARY OF THE INVENTION

The present invention has been made in an effort to provide users with a more advanced function, namely, advertisements related to a broadcast advertisement in order to maximize the effect of advertising in a broadcasting environment in which bi-directional broadcasting services are supported and easy data exchange is implemented between a broadcasting terminal and mobile terminals (mobile phones, laptop computers, netbooks, PMP, game consoles, etc.) for playing related advertisements, the broadcasting network interworking with the Internet network for the bi-directional broadcasting services.

Further, the present invention has been made in an effort to provide supplementary data synchronized with a broadcast advertisement to mobile terminal users as described above.

An exemplary embodiment of the present invention provides an apparatus for providing related advertisements, including: a communication unit for receiving ID (identifier) information required for searching for advertisements related to a broadcast advertisement and transmitting converted related advertisements to a mobile terminal; a search unit for searching for the related advertisements by means of the ID information; and a conversion unit for converting the searched related advertisements to a format to be played in the mobile terminal.

The apparatus for providing related advertisements may receive the ID information from a mobile terminal.

The apparatus for providing related advertisements may further include a communication unit for receiving the ID information and transmitting the converted related advertisements to the mobile terminal.

The search unit may search for the related advertisements by means of identification codes included in the video of a broadcast advertisement.

The ID information may include a URL (Uniform Resource Locator) address for searching for the related advertisements included in the broadcast advertisement by means of the Internet browser.

Another exemplary embodiment of the present invention provides a mobile terminal for playing related advertisements, including: an ID information communication unit for requesting ID used for receiving the advertisements related to a broadcast advertisement in the broadcast terminal which plays the broadcast advertisement and for receiving the requested ID; a related advertisement communication unit for requesting related advertisements to an apparatus for providing related advertisements by means of the ID information and for receiving the requested related advertisements; and a related advertisement play unit for playing the received related advertisements.

The mobile terminal for playing related advertisements may further include an ID information extraction unit for analyzing the ID codes transmitted together with the broadcast advertisement and then for extracting ID information used for searching for advertisements related to the broadcast advertisement.

The related advertisements may be provided as contents to be played by the Internet browser.

The mobile terminal for playing the related advertisements may further include an input unit for receiving a user's input for requesting ID information used for receiving advertisements related to the broadcast advertisement.

Yet another exemplary embodiment of the present invention provides a method for providing personalized related advertisements, including: receiving ID information used for searching for advertisements related to a broadcast advertisement; searching for related advertisements by means of the received ID information; converting the searched related advertisements to a format to be played in a mobile terminal; and transmitting the converted related advertisements to the mobile terminal.

The method for providing personalized related advertisements may further include analyzing ID codes included in the video of a broadcast advertisement to extract ID information related to the broadcast advertisement.

The method for providing personalized related advertisements may further include converting the related advertisements included in the broadcast advertisement to a format of contents to be played by the Internet browser.

The method for providing personalized related advertisements may further include receiving the ID information from a mobile terminal which plays the related advertisements.

According to exemplary embodiments of the present invention, users can be provided with diversified pieces of purchase information through relevant advertisements related to a broadcast advertisement.

According to exemplary embodiments of the present invention, it is possible to provide users with advertisements related to a broadcast advertisement, in order to provide advertisements required by the users.

According to exemplary embodiments of the present invention, it is possible to improve the effect of advertising by providing users with advertisements related to a broadcast advertisement.

According to exemplary embodiments of the present invention, it is possible to provide opportunities for creating diversified business models related to broadcast advertisements to contribute to increasing profits of service providers or manufacturers.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing a system for providing users with advertisements related to a broadcast advertisement according to an exemplary embodiment of the present invention.

FIG. 2 is a block diagram illustrating an apparatus for providing related advertisements according to an exemplary embodiment of the present invention.

FIG. 3 is a diagram showing a system for providing users with advertisements related to a broadcast advertisement according to another exemplary embodiment of the present invention.

FIG. 4 is a flow chart showing a method for providing users with advertisements related to a broadcast advertisement according to the present invention.

FIG. 5 is a flow chart showing a method for providing users with advertisements related to a broadcast advertisement according to yet another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

Exemplary embodiments of the present invention may be implemented by various means. For example, the exemplary embodiments of the present invention may be implemented firmware, software, or a combination thereof, or the like.

In the implementation by the hardware, a method according to exemplary embodiments of the present invention may be implemented by application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the implementation using the firmware or the software, a method according to exemplary embodiments of the present invention may be implemented by modules, procedures, functions, or the like, that perform functions or operations described above. Software codes are stored in a memory unit and may be driven by a processor. The memory unit is disposed in or out the processor and may transmit and receive data to and from the well-known various units.

Specific terms are provided to help understandings of the present invention. The use of the specific terms may be changed into other forms without departing from the technical idea of the present invention.

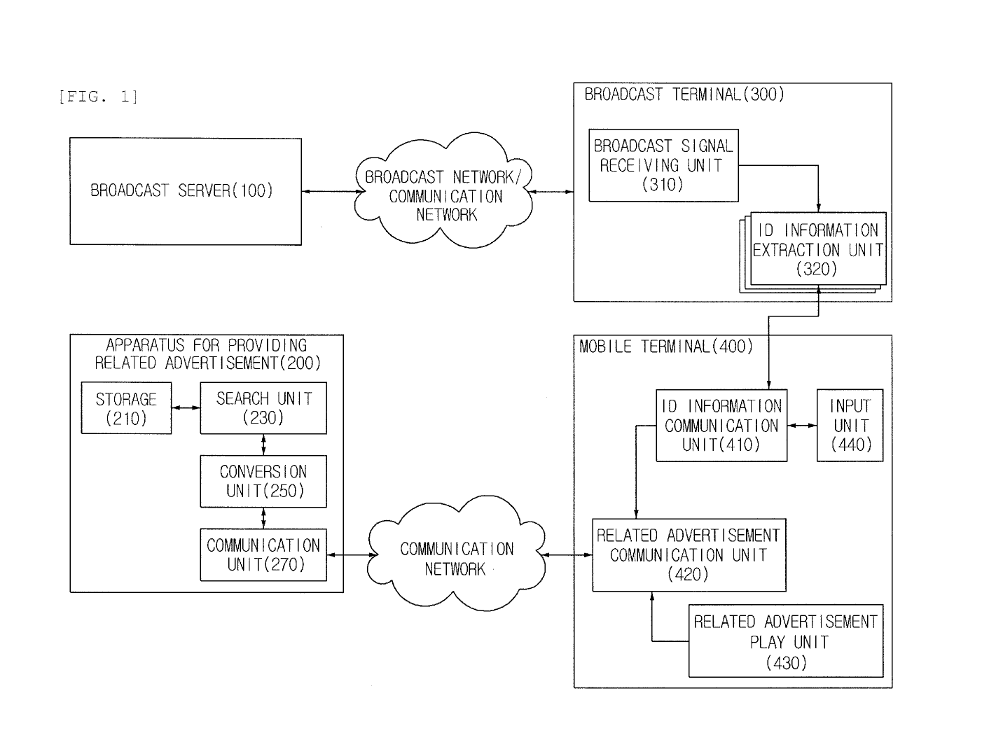

FIG. 1 is a diagram showing a system for providing users with advertisements related to a broadcast advertisement according to an exemplary embodiment of the present invention.

The system for providing a user with advertisements related to a broadcast advertisement according to the exemplary embodiment of the present invention includes a broadcasting server 100 for transmitting broadcast programs and broadcast advertisements via a broadcast communication network including terrestrial networks, satellite cables, IPTV, etc., an apparatus 200 for providing advertisements related to the broadcast advertisement, a broadcast terminal 300 for receiving broadcast signals to play broadcast contents and broadcast advertisements on the screen thereof, to analyze the ID information of related advertisements included in the broadcast advertisement, and to transmit the analyzed ID information to a mobile terminal 400, and the mobile terminal 400 for requesting the ID information received from the broadcast terminal 300 to the apparatus 200 for providing related advertisements and for playing the received related advertisements.

The broadcast server 100 serves to transmit broadcast programs and broadcast advertisements as digital broadcast signals. The digital broadcast signals are transmitted via conventional terrestrial networks/satellites/cables/IPTV networks, etc. To this end, the broadcast server 100 may have functions of contents input for receiving broadcast contents from contents providers, contents storage for storing the broadcast contents, encoding the broadcast contents, and transmission (modulator, amplifier) for transmitting the encoded contents via a broadcast network. That is, the server 100 may be considered as a digital broadcast transmission system which is installed for providing digital broadcasting in a broadcasting station.

The broadcast server 100 may create diversified types of ID information in order to allow users to search for information related to a broadcast advertisement in addition to the aforementioned functions essential to a digital broadcasting transmission system.

For example, the server 100 may create ID codes of PDF417, Data Matrix, Maxi Code, Color Code, etc., for ID information of advertisements related to the broadcast advertisement to insert the ID codes in a relevant broadcast advertisement video for transmission.

The broadcast server 100 normally stores related advertisements for transmitted broadcast advertisements and searches for and transmits the relevant related advertisements to a user according to the user's request.

Here, the apparatus 200 for providing related advertisements may stores related advertisements so that the advertisements are searched for by means of ID information transmitted together with a broadcast advertisement.

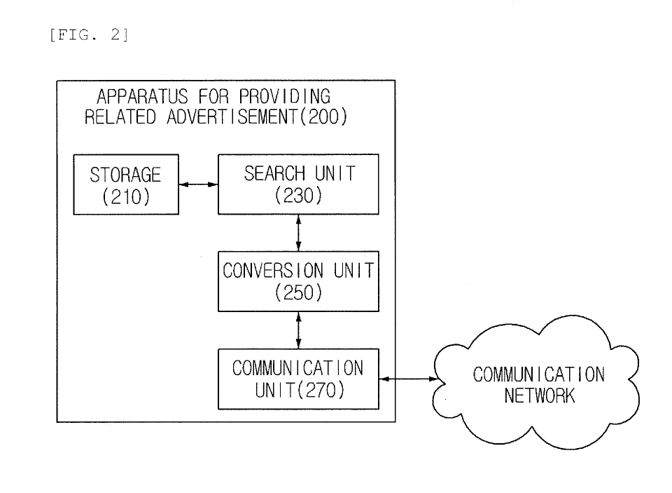

FIG. 2 is a block diagram illustrating an apparatus for providing related advertisements according to an exemplary embodiment of the present invention.

The apparatus 200 for providing related advertisements includes a storage 210 for storing advertisements related to a broadcast advertisement, a search unit 230 for searching for the related advertisements by means of ID information, a conversion unit 250 for converting the searched related advertisements to a format appropriate for being played in the mobile terminal 400, and a communication unit 270 for receiving the ID information used for searching for advertisements related to a broadcast advertisement and transmitting the converted related advertisements to a mobile terminal.

Here, the advertisements related to a broadcast advertisement pertain to supplementary information on products played in the broadcast advertisement.

For example, if a mobile phone advertisement is played on the screen of a broadcast terminal, the advertisement related thereto includes information for the relevant product, e.g., reviews about the phone, mobile phone CF, video uploaded to YouTube, comparison of prices and the like.

Further, the related advertisement may include information on comparable products to the relevant product played in the broadcast advertisement.

Here, a broadcast advertisement, e.g., home shopping, may be provided as supplementary data to data broadcasting in a broadcast terminal for additional purchase information related to a broadcast advertisement in the terminal and may be displayed in a mobile terminal in real time while the broadcast advertisement is on the air.

The ID information for searching for advertisements related to the broadcast advertisement is used for searching for advertisements related to the relevant broadcast advertisement, and may includes a URL (Uniform Resource Locator) where the relevant related advertisements are located, an ID (identifier) required for searching for the relevant the related advertisements and the like. The ID information may additionally include texts and the like which include information of the relevant broadcast advertisement.

The broadcast terminal 300 receives and plays broadcast advertisements. If the mobile terminal 400 requests related advertisements for the broadcast advertisement currently viewed to the terminal 300, the terminal 300 analyzes ID codes, e.g., PDF417, Data Matrix, Maxi Code, Color Code and the like transmitted along with the current broadcast advertisement to extract related advertisement ID information required for searching for the advertisements related to the relevant advertisement, and then transmits the extracted related advertisement ID information to the mobile terminal 400. For analyzing the code information included in the broadcast advertisement video, the broadcast terminal 300 acquires one scene in the video of relevant broadcast advertisement according to the request of a mobile terminal to recognize the code information scene in all of the scenes through video processing and then to extract ID information included in the relevant ID code.

Here, the ID information includes a URL or an ID and the like used for searching for the advertisements related to the relevant broadcast advertisement and may further include information related to the relevant broadcast advertisement.

The broadcast terminal 300 may includes a broadcast signal receiving unit 310 for receiving broadcast advertisements transmitted by the broadcast server 100 and an ID information extraction unit 320 for extracting ID information for searching for the advertisements related to the broadcast advertisement.

The broadcast signal receiving unit 310 receives digital broadcast signals via a broadcasting network to play broadcast programs and broadcast advertisements on a user's TV screen and transmits broadcast advertisements or broadcasting transmission streams to the ID information extraction unit 320.

The ID information extraction unit 320 receives a request for related advertisement ID information sent by a user through the mobile terminal 400 to analyze ID codes, e.g., PDF417, Data Matrix, Maxi Code, Color Code and the like transmitted together with the current broadcast advertisement and to extract related advertisement ID information required for searching for the advertisements related to the relevant advertisement to transmit the extracted related advertisement ID information to the mobile terminal 400.

The mobile terminal 400 may be a multimedia terminal carried by a user and examples thereof include mobile phones, PMP, laptop computers, netbooks, e-books and gaming consoles, etc.

The mobile terminal 400 sends a request to the remote apparatus 200 for providing related advertisements by means of the ID information for related advertisements and receives relevant related advertisements via a communication network (IPTV network, Internet network, etc.). In this case, the relevant related advertisements may be provided in a format to be played in the mobile terminal.

Specifically, the mobile terminal 400 may be provided with the advertisements in a format of contents to be played by the Internet browser, the contents being sent by the apparatus 200 for providing related advertisements.

As another example, if the mobile terminal is equipped with an H.264 decoder, the server 200 for providing related advertisements may be provided with the relevant related advertisements as H.264-based video to be played in the mobile terminal.

The mobile terminal 400 may includes an ID information communication unit 410 for requesting ID information to the broadcast terminal for playing broadcast advertisements in order to receive the advertisements related to the broadcast advertisement and for receiving the requested ID information, a related advertisement communication unit 420 for requesting related advertisements to the apparatus for providing related advertisements by means of the ID information and for receiving the requested related advertisements, a related advertisement play unit 430 for playing the received related advertisements, and an input unit 440 for receiving user's input requesting the ID information to receive the advertisements related to the broadcast advertisement.

The ID information communication unit 410 transmits a user's request for the advertisements related to the broadcast advertisement currently played in the broadcast terminal to the ID information extraction unit 320. The ID information communication unit 410 receives the extracted related advertisement ID information from the ID information extraction unit 320 to transmit the information to the related advertisement communication unit 420.

The related advertisement communication unit 420 requests the relevant related advertisements to the apparatus 200 for providing related advertisements by means of the related advertisement ID information transmitted from the ID information communication unit 410 and then transmits the related advertisements transmitted from the related advertisement server 200 to the related advertisement play unit 430.

The related advertisement play unit 430 plays the related advertisements transmitted from the related advertisement communication unit 420 to enable the user to view the advertisements on the screen to show the advertisements on the user's screen.

Here, the related advertisement play unit 430 may be provided as a 3D display for implementing stereoscopic video to be played and viewed.

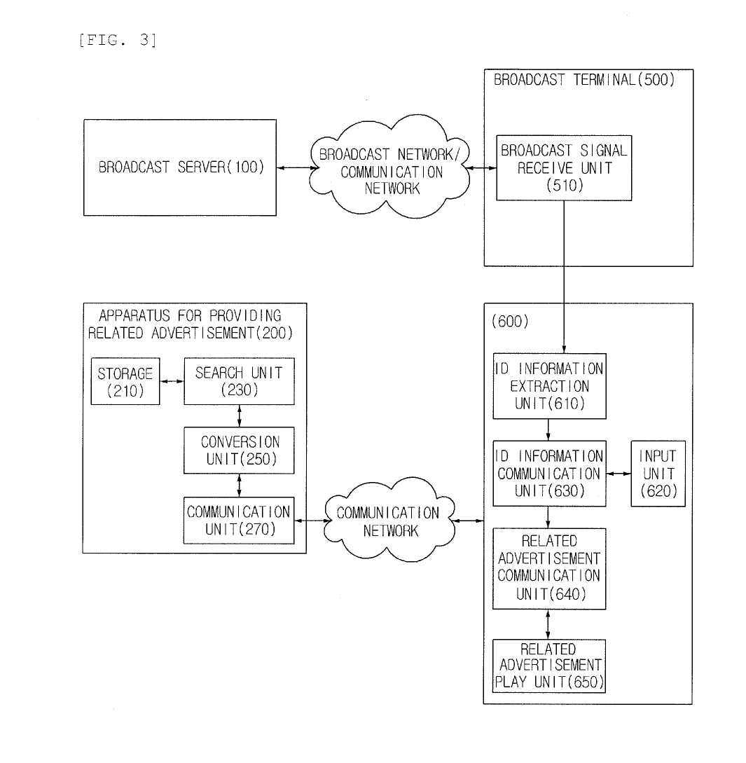

FIG. 3 is a diagram showing a system for providing a user with advertisements related to a broadcast advertisement according to another exemplary embodiment of the present invention.

As shown in FIG. 3, the system for providing related advertisements according to the exemplary embodiment of the present invention includes a broadcast server 100 for transmitting broadcast programs and broadcast advertisements in broadcast signals via a broadcast communication network (terrestrial/satellite/cable/IPTV networks, etc.), an apparatus 200 for providing related advertisements for providing advertisements related to a broadcast advertisement according to the request of a mobile terminal 600, a broadcast terminal 500 for receiving broadcast signals to play broadcast programs and broadcast advertisements on the screen thereof and for transmitting broadcast advertisement video including a user's related advertisement ID information according to the request of mobile terminal 600, and the mobile terminal 600 for extracting related advertisement ID information from the broadcast advertisement video transmitted from the broadcast terminal 500 and for requesting related advertisement to the apparatus 200 for providing related advertisements by means of the extracted related advertisement ID information to receive transmitted related advertisements to play them on a screen of user's mobile terminal.

The exemplary embodiment shown in FIG. 3 illustrates the case that the ID information extraction unit 320 included in the broadcast terminal is included as one component of the mobile terminal 600, and the broadcast advertisement video is directly transmitted from the broadcast terminal 500 to the mobile terminal 600.

Component in FIG. 6 is identical to component with the same name in FIG. 3.

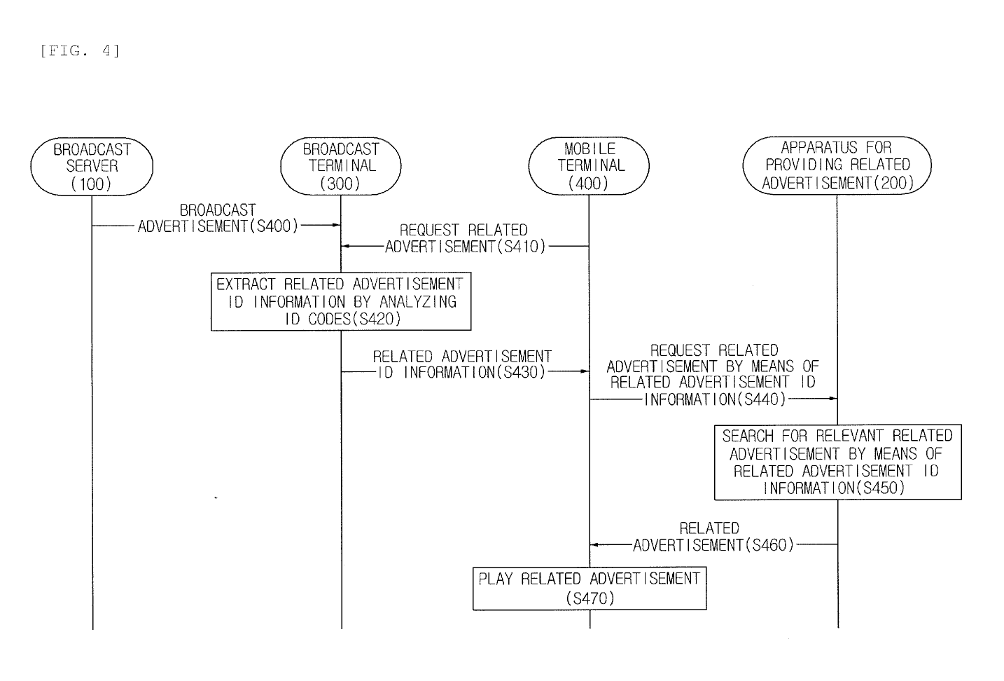

FIG. 4 is a flow chart showing a method for providing a user with advertisements related to a broadcast advertisement according to the present invention.

Hereinafter, referring to FIG. 4, the flow will be described for a method for providing a user with advertisements related to a broadcast advertisement according to an exemplary embodiment of the present invention.

The broadcast server 100 transmits broadcast advertisements to the broadcast terminal 300 via a broadcast network (terrestrial network, satellite network, or cable network) or a communication network (IPTV network, Internet network, etc.) (S400).

Here, the broadcast advertisements are created to have ID information in diversified formats to enable a user to search for supplementary information related to the broadcast advertisements.

Subsequently, the broadcast terminal 300 plays the transmitted broadcast advertisements, and a user who watches broadcast advertisements requests related advertisements by means of the mobile terminal 400 (S410).

The ID information is used for searching for advertisements related to the relevant broadcast advertisement and may be provided with a URL (Uniform Resource Locator) where the relevant related advertisements are located or an ID (Identifier) required for searching for the relevant related advertisements, the information being requested via the input unit 440 of the mobile terminal 400.

The broadcast terminal 300 receives and plays broadcast advertisements. When the mobile terminal 400 requests related advertisements for the broadcast advertisement currently viewed, the terminal 300 analyzes ID codes, e.g., PDF417, Data Matrix, Maxi Code, Color Code and the like transmitted together with the current broadcast advertisement to extract related advertisement ID information required for searching for the advertisements related to the relevant advertisement (S420).

The broadcast terminal 300 transmits the extracted related advertisement ID information to the mobile terminal 400 (S430).

The mobile terminal 400 requests ID information used for receiving advertisements related to a broadcast advertisement to the broadcast terminal which plays the broadcast advertisement, receives the requested ID information from the ID information communication unit 410, and then requests the relevant related advertisements to the apparatus 200 for providing related advertisements by means of the ID information (S440).

The apparatus 200 for providing related advertisements searches for the relevant related advertisements by means of the related advertisement ID information (S450).

The apparatus 200 for providing related advertisements transmits the searched related advertisements to the mobile terminal 400 (S460).

The mobile terminal 400 plays the related advertisements to provide the related advertisements on the screen thereof (S470).

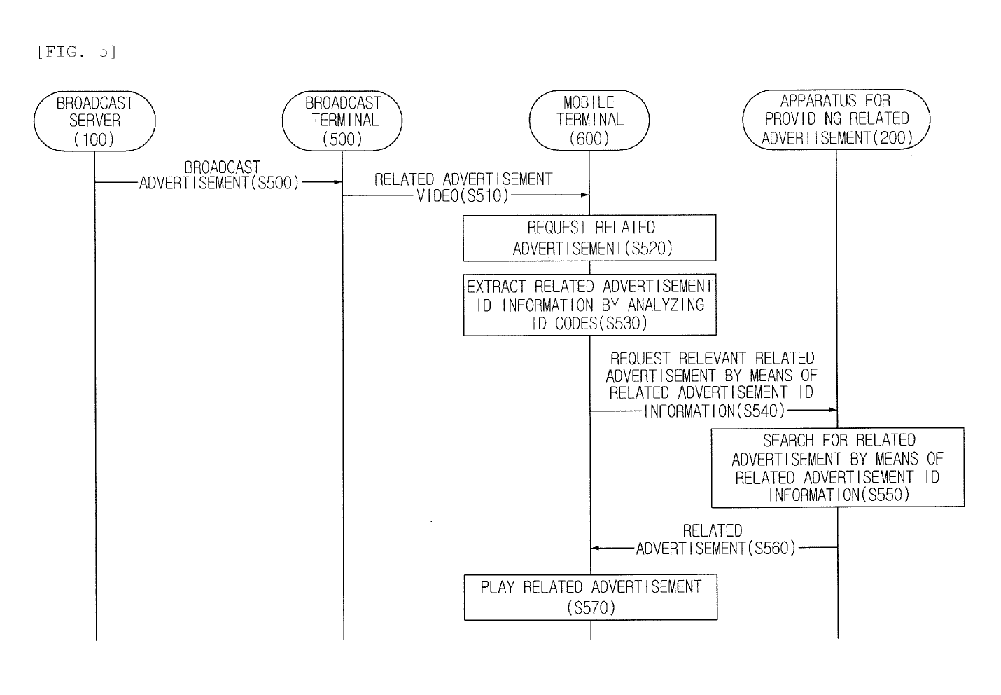

FIG. 5 is a flow chart showing a method for providing a user with advertisements related to a broadcast advertisement according to yet another exemplary embodiment of the present invention.

Hereinafter, referring to FIG. 5, a method for providing a user with advertisements related to a broadcast advertisement according to yet another exemplary embodiment will be described.

The exemplary embodiment which will be described hereinafter relates to a method for providing a user with advertisements related to a broadcast advertisement, wherein the ID information extraction unit 320 included in the broadcast terminal is included as one component of the mobile terminal 600.

The broadcast server 100 transmits broadcast advertisements to the broadcast terminal 500 via a broadcast network (terrestrial network, satellite network, cable network) or a communication network (IPTV network, Internet network, etc.) (S500). The broadcast terminal 500 transmits broadcast advertisement video to the mobile terminal 600 (S510). A user who views the broadcast advertisement requests related advertisements by means of the mobile terminal 600 (S520).

The mobile terminal 600 analyzes ID codes transmitted together with the broadcast advertisement to extract advertisement ID information related to the relevant broadcast advertisement (S530). The mobile terminal 600 requests the relevant related advertisements to the server 200 for providing related advertisements by means of the extracted related advertisement ID information (S540). The apparatus 200 for providing related advertisements searches for the relevant related advertisements by means of the related advertisement ID information (S550). The server 200 for providing related advertisements transmits the searched related advertisements to the mobile terminal 600 (S560). The mobile terminal 600 plays the related advertisements to provide the related advertisements to the screen of user's mobile terminal (S570).

An apparatus for providing personalized related advertisements to provide advertisements related to a broadcast advertisement, a mobile terminal for playing related advertisements, and a method for providing personalized related advertisements according to the present invention may additionally provide advertisements related to a broadcast advertisement and may be applicable to bi-directional broadcast services.

Accordingly, the present invention may be applicable to the field of providing advertisement services by means of mobile terminals.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for providing related advertisements, comprising:
a communication unit for receiving ID (identifier) information required for searching for advertisements related to a broadcast advertisement and transmitting converted related advertisements to a mobile terminal;
a search unit for searching for the related advertisements by means of the ID information; and
a conversion unit for converting the searched related advertisements to a format to be played in the mobile terminal.

2. The apparatus of claim 1, wherein the communication unit receives ID information used for searching for advertisements related to a broadcast advertisement from the mobile terminal.

3. The apparatus of claim 1, wherein the search unit searches for the related advertisements by means of ID codes included in the video of a broadcast advertisement.

4. The apparatus of claim 1, wherein the ID information comprises a URL (Uniform Resource Locator) address for searching for the related advertisements included in the broadcast advertisement by means of the Internet browser.

5. A mobile terminal for playing related advertisements, comprising:
an ID information communication unit for requesting ID information used for receiving advertisements related to a broadcast advertisement in a broadcast terminal which plays the broadcast advertisement and for receiving the requested ID information;
a related advertisement communication unit for requesting the related advertisements to the apparatus for providing related advertisements by means of the ID information and for receiving the requested related advertisements; and
a related advertisement play unit for playing the received related advertisement.

6. The mobile terminal of claim 5, further comprising:
an ID information extraction unit for analyzing ID codes transmitted together with the broadcast advertisement and for extracting ID information used for searching for advertisements related to the broadcast advertisement.

7. The mobile terminal of claim 5, wherein the related advertisements are provided as contents to be played by the Internet browser.

8. The mobile terminal of claim 5, further comprising:
an input unit for receiving a user's input requesting ID information used for receiving advertisements related to the broadcast advertisement.

9. The mobile terminal of claim 5, wherein the play unit plays related advertisements in real time while the broadcast advertisement is on the air.

10. A method for providing personalized related advertisements, comprising:
receiving ID information used for searching for advertisements related to a broadcast advertisement;
searching for related advertisements by means of the received ID information;
converting the searched related advertisements to a format to be played in a mobile terminal; and
transmitting the converted related advertisements to the mobile terminal.

11. The method of claim 10, further comprising:
analyzing ID codes included in broadcast advertisement video to extract ID information related to the broadcast advertisement.

12. The method of claim 10, further comprising:
converting the related advertisements included in the broadcast advertisement to a format of contents to be played by the Internet browser.

13. The method of claim 10, wherein the receiving of the ID information is to receive ID information from a mobile terminal.

14. The method of claim 10, further comprising:
analyzing the ID codes transmitted in real time together with the currently received broadcast advertisement to extract related advertisement ID information.
